(19) United States
(12) Patent Application Publication
(10) Pub. No.: US 2016/0079639 A1
(43) Pub. Date: Mar. 17, 2016

(54) COOLING FIN FOR A BATTERY CELL

(71) Applicant: James O. Pinon, Troy, MI (US)

(72) Inventor: James O. Pinon, Troy, MI (US)

(21) Appl. No.: 14/853,936

(22) Filed: Sep. 14, 2015

Related U.S. Application Data
(60) Provisional application No. 62/050,670, filed on Sep. 15, 2014.

(51) Int. Cl. H01M 10/6556; H01M 10/6551

(52) U.S. Cl. CPC H01M 10/6556; H01M 10/6551

(57) ABSTRACT

An apparatus is provided for cooling a multi-cell energy storage device. The apparatus includes a plurality of cooling fins and a cooling tube configured to transfer heat from the cooling fins to a flow of coolant within the cooling tube. Each cooling fin includes a metallic substrate and a cooling tube gripping feature. According to one embodiment, each cooling fin can be a graphene enhanced cooling fin.

This disclosure claims the benefit of U.S. Provisional Application No. 62/050,670 filed on Sep. 15, 2014 which is hereby incorporated by reference.

### TECHNICAL FIELD

This disclosure is related to thermal management systems used in energy storage devices. In particular, the disclosure is related to heat management in multi-cell devices, for example, used in electrically powered or hybrid power vehicles or stationary or back-up power systems.

### BACKGROUND

The statements in this section merely provide background information related to the present disclosure. Accordingly, such statements are not intended to constitute an admission of prior art.

Batteries used in vehicular-scale energy storage generate significant heat, for example, during charging cycles and during power generation/discharge cycles. Placing fins, for example, made of steel or aluminum between battery cells is known whereby the fins act as heat sinks, drawing heat away from the battery cells and transmitting the heat away from the batteries. However, package space within battery packs is limited, and the fins generally must be thin to fit the required package size. As a result, simple fins are limited in how much heat they can manage in a battery pack including multiple battery cells.

Other cooling fin configurations are known. One configuration includes a hollow fin passing a liquid through the fin and exchanging heat from the proximate battery cells into the liquid which is then cycled out of the fin and cooled through known thermal cycles. However, such systems are inherently complex, requiring waterproof seals at every connection point; expensive, requiring a liquid pump and a connecting heat exchanger to dissipate the heat; and prone to exposing the battery cells to liquid from leaking fins and connections.

### SUMMARY

An apparatus is provided for cooling a multi-cell energy storage device. The apparatus includes a plurality of cooling fins and a cooling tube configured to transfer heat from the cooling fins to a flow of coolant within the cooling tube. Each cooling fin includes a metallic substrate and a cooling tube gripping feature. According to one embodiment, each cooling fin can be a graphene enhanced cooling fin.

### BRIEF DESCRIPTION OF THE DRAWINGS

One or more embodiments will now be described, by way of example, with reference to the accompanying drawings, in which:

FIG. 1 illustrates an exemplary graphene enhanced cooling fin for use in a multi-cell battery pack, in accordance with the present disclosure;

FIG. 2 illustrates in side view the cooling fin of FIG. 1, in accordance with the present disclosure;

FIG. 3 illustrates a stack of the graphene enhanced cooling fins including battery cells located between the cooling fins and a liquid filled cooling tube ready to be snapped to a side of the stack, in accordance with the present disclosure;

FIG. 4 illustrates the stack of FIG. 3 with the cooling tube installed thereto, in accordance with the present disclosure;

FIG. 5 illustrates an exemplary alternative cooling tube and cooling tube gripping feature including a round tube and C-shaped clip, in accordance with the present disclosure;

FIG. 6 illustrates an additional exemplary alternative cooling tube and cooling tube gripping feature, including a fastened gripping band, in accordance with the present disclosure;

FIG. 7 illustrates an additional exemplary alternative cooling tube and cooling tube gripping feature, including a tab and a punched hole in the tab, in accordance with the present disclosure;

FIG. 8 illustrates in side view an additional exemplary embodiment of a graphene enhanced cooling fin, including a battery cell containing depression, in accordance with the present disclosure;

FIG. 9 illustrates in front view the cooling fin of FIG. 8, in accordance with the present disclosure;

FIG. 10 illustrates an exemplary cooling fin spacing feature, in accordance with the present disclosure;

FIG. 11 illustrates an exemplary alternative cooling fin spacing feature, in accordance with the present disclosure;

FIG. 12 illustrates an additional exemplary embodiment of a graphene enhanced cooling fin, including a battery cell containing depression and four structural mounting tabs, in accordance with the present disclosure;

FIG. 13 illustrates a plurality of cooling fins of FIG. 12 assembled into a stack, in accordance with the present disclosure;

FIG. 14 illustrates an exemplary cooling fin with a bend configured to improve structural rigidity of the fin, in accordance with the present disclosure;

FIG. 15 illustrates an exemplary cooling fin with a plurality of bends configured to improve structural rigidity of the fin in accordance with the present disclosure;

FIG. 16 illustrates an exemplary plurality of prismatic battery cells, each including a respective cooling fin wrapped thereabout, in accordance with the present disclosure; and

FIG. 17 illustrates an exemplary plurality of cylindrically-shaped energy storage devices and a plurality of cooling fins, each including arcuate sections configured to wrap around and contact the cylindrically-shaped energy storage devices, in accordance with the present disclosure.

### DETAILED DESCRIPTION

A device or apparatus including a cooling fin for use in multiple cell battery packs is disclosed, replacing traditional cooling fins and related designs used to remove heat from or transfer heat to battery cells, fuel cells, multiple cell capacitors, or similar energy storage devices.

Throughout the disclosure, heat is generally discussed as being taken away from a battery cell or cells. It will be appreciated that the same structure of cooling fins can be used to heat battery cells or other energy storage cells. In such an embodiment, a coolant heating device can be used, for example, to generate heat through electrical resistance or burning of fuel, and heat can be supplied to an exemplary battery under cold environmental conditions to achieve a desired operating temperature for the energy storage device.

Graphene is a substance that greatly increases thermal conductivity of a cooling fin substrate. Use of a graphene enhanced cooling fin is disclosed. Enhancing a cooling fin with graphene can be performed according to a number of envisioned embodiments. For example, a single layer of graphene can be applied or deposited upon one or both sides of a metallic substrate. In another example, layers of graphene can be used upon and between layers of metallic substances. For example, a cooling fin can include layers of aluminum, copper, and/or steel, with layers of graphene deposited between the multiple layers of metal. In another embodiment, graphene can be mixed with a metal and interspersed within the metal to enhance the metal's properties. Such a composite material can be held together with a binder material. Layers can be joined or bonded together according to processes known in the art.

In another example, a layer or layers of electrical or flame-retardant insulation can be used with the metallic substrate. In another example, expansion-absorbing layers known as gap pads can placed internally or externally to the cooling fin.

While layers of graphene of thicknesses of up to or over 0.5 mm are known and contemplated for use with the presently disclosed cooling fins, layers of as little as one molecule thick can be used upon a cooling fin substrate in accordance with the presently disclosed device. Solid-metal fin substrates can used to transfer heat, which is generated from the center of a cell, to the edges, where cooling tubes or cold plates in thermally conductive contact with the cooling fin. The disclosed graphene enhancements greatly increase a capacity of a solid metal substrate to conduct heat. As a result, whereas previous designs, such as multi-cell battery packs, with large amounts of heat being generated had too high of cooling requirements to utilize solid metal substrates, the graphene enhanced cooling fins of the present disclosure enable adequate heat conduction to permit the use of solid metal substrates in such high heat applications.

Throughout the disclosure, examples are provided including graphene layers or graphene coated substrates. It will be appreciated that any graphene enhancement can be substituted for layers or coatings.

Further, graphene enhanced cooling fins are useful for applications where a large amount of heat must be removed or transferred to or from a device. However, the structures disclosed herein and illustrated in the figures can be used with simple metallic fins, such as aluminum fins, depending upon the heat transfer requirements of the application. The disclosure is intended to encompass any metallic structure with the disclosed properties. Graphene is an embodiment with advantageous properties, but for reasons such as cost, the disclosed device or apparatus can be constructed of an exemplary all aluminum configuration. At any point in the disclosure, the applicant intends that a graphene enhanced cooling fin can be substituted with a simple metal cooling fin.

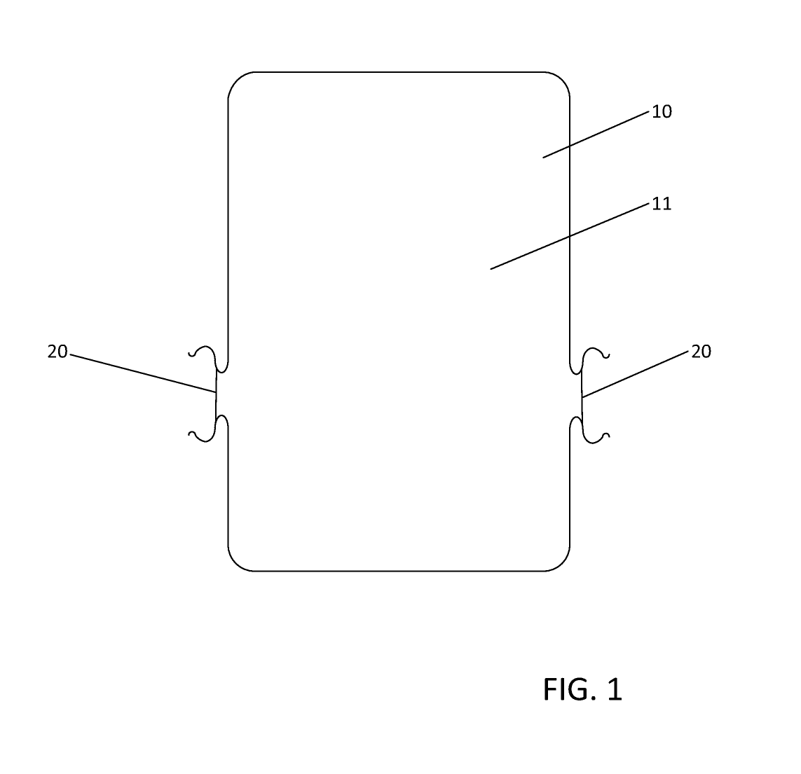

Referring now to the drawings, wherein the showings are for the purpose of illustrating certain exemplary embodiments only and not for the purpose of limiting the same, FIG. 1 illustrates an exemplary graphene enhanced cooling fin for use in a multi-cell battery pack. Graphene enhanced cooling fin 10 is illustrated including a flat planar body portion 11 and a plurality of cooling tube gripping features 20. Gripping features 20 include a pair of arcuate tabs configured to wrap around and snappingly secure a cooling tube. Gripping feature tabs can but need not include lead in arcuate bends to facilitate snapping of a tube into place. Body portion 11 is illustrated with a large surface area configured to be situated in direct contact with a generally rectangle-shaped batter cell on one side of the body portion or one on each side of the body portion. Graphene can be coated on one or both sides of the cooling fin.

Cooling fin 10 can be constructed in any of a number of ways known in the art. In one exemplary manufacturing method, the metal substrate can be stamped out of an exemplary aluminum sheet of uniform thickness. Gripping features 20 can be stamped out of the same sheet of material as body portion 11 and bent into the desired shape. In other embodiments, gripping features 20 can be constructed separately and attached to body portion 11. Ideally gripping features 20 and the attached cooling tube can both be coated with graphene to maximize heat transfer from the cooling fin 10 to the coolant passing through the cooling tube or tubes. Two sets of gripping features 20 are illustrated. Depending upon the thermal capacity required and the capacity of the cooling tube, one, two, or more than two sets of gripping features 20 can be attached to the cooling fin 10. In one embodiment, a cooling fin with four sets of gripping features can be produced, and different models of stacks of cooling fin can use one, two, three, or all four of the sets as needed.

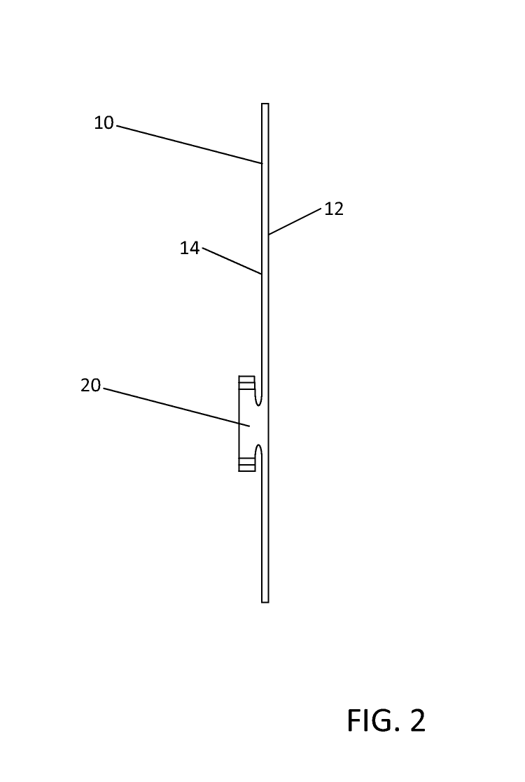

FIG. 2 illustrates in side view the cooling fin of FIG. 1. Cooling fin 10 is illustrated including first side 12 of the cooling fin and second side 14 of the cooling fin. Graphene can be applied to either side 12 and/or side 14 depending upon factors such as cost and thermal conductivity requirements of the application. Gripping feature 20 is illustrated.

FIG. 3 illustrates a stack of the graphene enhanced cooling fins including battery cells located between the cooling fins and a liquid filled cooling tube ready to be snapped to a side of the stack. A plurality of cooling fins 10 are illustrated, each including a gripping feature 20. Generally rectangle-shaped battery cells 30 are illustrated between the cooling fins 10. Gripping features 20 are configured to easily receive and firmly retain cooling tube 40. Cooling tube 40 can be constructed of aluminum or any other material known in the art for containing coolant through a cooling loop. Tube 40 is illustrated as a short segment for illustration purposes. It will be appreciated that tube 40 is actually part of a contained coolant loop where a pump forces coolant through the coolant loop, the coolant loop accepts heat from the disclosed cooling fins, and subsequently rejects heat through a heat exchanger.

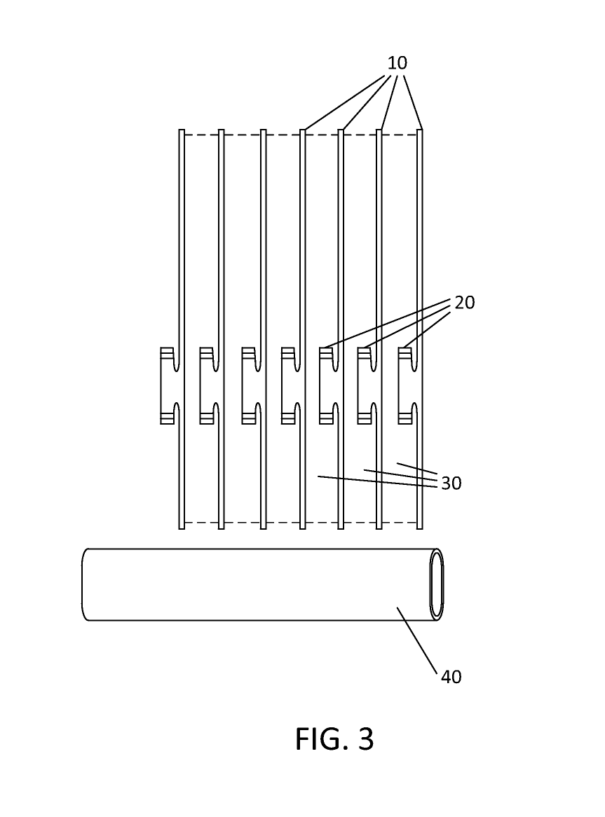

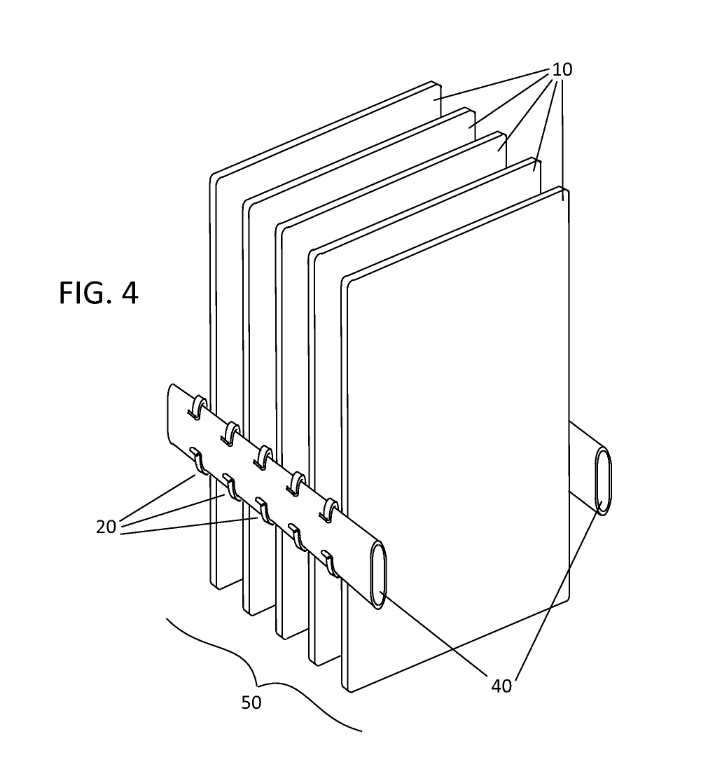

FIG. 4 illustrates the stack of FIG. 3 with cooling tubes installed thereto. Cooling fin stack 50 is illustrated including a plurality of graphene enhanced cooling fins 10, each including a pair of gripping features 20, and cooling tubes 40 installed to the gripping features 20. The illustrated configuration and similar configurations according to the present disclosure include a number of advantages over previous configurations. Previous battery cooling fins required liquid coolant to pass between the battery cells. Whereas each cooling fin 10 is coated or otherwise improved with graphene and includes the enhanced thermal conductivity that is enabled with use of graphene, no fluid is required to pass between and through the battery cells. The all metal substrate configuration of FIG. 4 avoids cost and warranty issues related to the complex sealing and routing of liquid through the cooling fins.

Further, flow resistance of a simple coolant circuit of cooling tubes around a stack of cooling fins is significantly lower than flow resistance in a circuit where coolant must be driven through a plurality of hollow cooling fins. In such a high flow resistance embodiment, a larger pump requiring significantly higher power is required than when the currently disclosed, all metallic fins are utilized. The disclosed cooling fins increase energy efficiency of the system through use of a smaller, more efficient coolant pump.

Further, the snap fit attachment of the cooling tubes to the gripping features saves manufacturing time and cost as compared to previous designs that had o-ring attachments of cooling tubes to liquid filled cooling fins.

Further, the cooling fins, wrapping around the cooling tubes, are configured to be mobile relative to the cooling tubes. Battery cells expand and contract with heat and use. Cooling fins 10 and gripping features 20 can slide along tubes 40 as the cells change dimensions. This mobility along the tubes reduces warranty failures and reduces wear upon the battery cells.

Further, the cooling fins can be made of various thicknesses and strengths of substrate materials. While the cooling fins 10 of FIG. 4 are illustrated including flat body portions, stiffening ribs and contours along the faces of cooling fins 10 can create structural strength in the cooling fins and reduce or eliminate the need for other structural members in the battery pack.

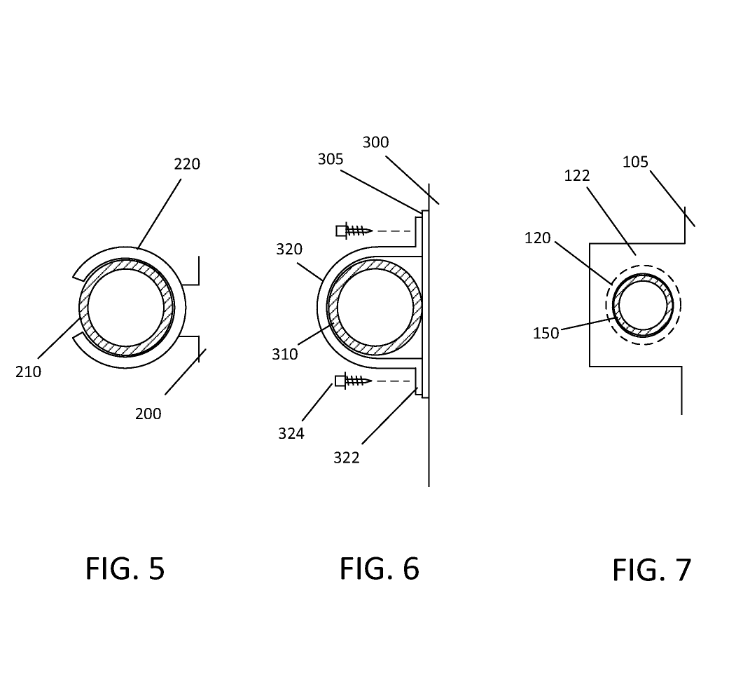

FIG. 5 illustrates an exemplary alternative cooling tube and cooling tube gripping feature including a round tube and C-shaped clip. Body portion 200 of a cooling fin is illustrated including a C-shaped clip gripping feature 220 holding a round cooling tube 210. FIG. 6 illustrates an additional exemplary alternative cooling tube and cooling tube gripping feature, including a fastened gripping band. Body portion 300 of a cooling fin is illustrated including a wrapping band member 320 bracketing round tube 310 to tab 305 bent at ninety degrees from body portion 300. Fasteners 324 are used to attach band member tabs 322 to tab 305 of body portion 300. FIG. 7 illustrates an additional exemplary alternative cooling tube and cooling tube gripping feature, including a tab and a punched hole in the tab. Body portion 105 is illustrated including tab 122 with a hole 120 punched in the tab. As hole 120 is punched, material around the hole can be extended outwardly from the surface of tab 122, such that when round tube 150 is provided within hole 120, increased surface area of the extended material is in contact with tube 150, in excess of the surface area that would be in contact if just the thickness of the tab were in contact with the tube.

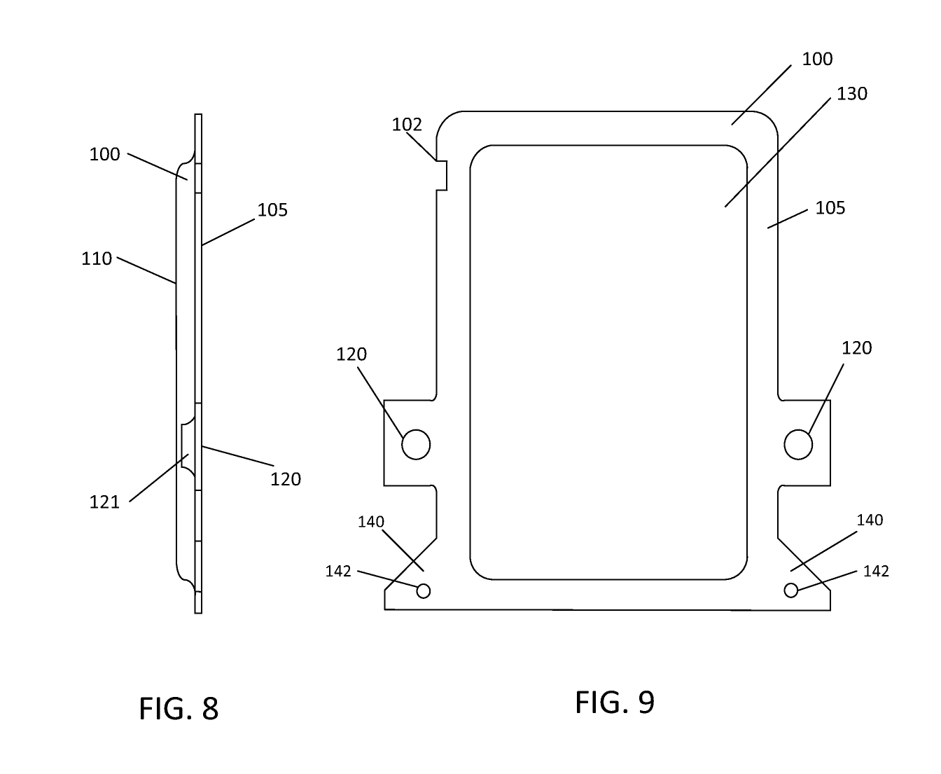

FIGS. 8 and 9 illustrate an additional exemplary embodiment of a graphene enhanced cooling fin, including a battery cell containing depression. FIG. 8 illustrates the cooling fin in side view, and FIG. 9 illustrates the cooling fin in front view. Cooling fin 100 is illustrated, including body portion 105, punched hole gripping features 120, battery cell holding depression 130, and structural mounting tabs 140. Depression 130 creates extended portion 110, seen in the side view extending from a flat normal face of body portion 105. Depression 130 adds to the structural rigidity of the cooling fin 100, such that a stack of cooling fins can be used to house a plurality of battery cells without other structural members.

Punched hole gripping features 120 include extended material 121 that is bent outwardly away from the surface of the tabs by the punching process. This extended material 121 increases surface area of contact between the tabs and a cooling tube inserted within gripping features 120.

Cooling fin 100 further includes structural mounting tabs 140 including mounting holes 142 which can be used to securely affix a battery pack including cooling fin 100 to the vehicle or device in which the battery pack is housed. In one exemplary use, a post can be inserted within mounting hole 142, thereby still enabling cooling fin 100 to move along the length of a cooling tube as the neighboring battery cells expand or contract. Additionally, bracket depression 102 is illustrated, enabling a stack of cooling fins 100 to be banded or bracketed together with an external device keying into depression 102.

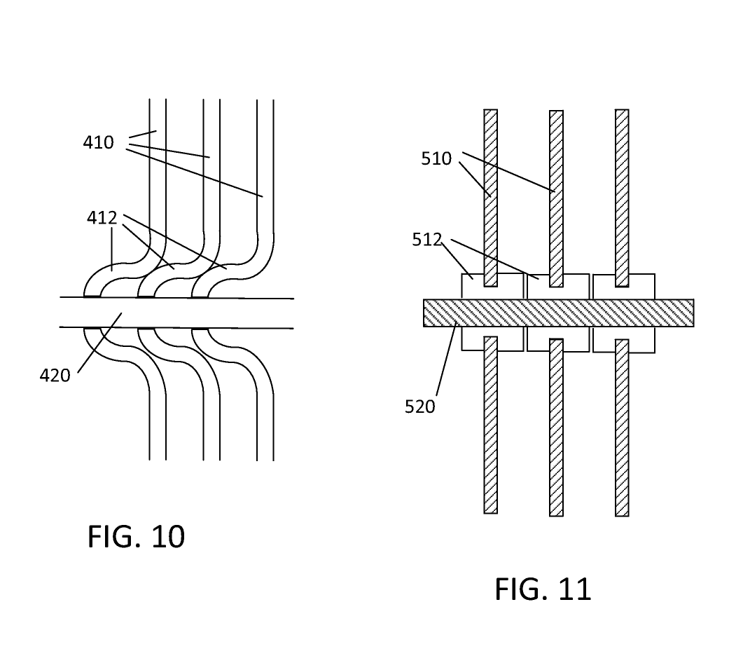

FIG. 10 illustrates an exemplary cooling fin spacing feature. A plurality of cooling fins 410 are illustrated mounted to a mounting post 420. Battery cells can be installed between the cooling fins 410. Spacing feature 412 can be created upon the cooling fins 410 with bent material of the cooling fin, for example, such as can be created with a punching or stamping process, such that stacked cooling fins 410 cannot get closer than a certain distance from each other, thereby protecting the battery cells therebetween. FIG. 11 illustrates an exemplary alternative cooling fin spacing feature. Cooling fins 510 are illustrated attached to mounting post 520 with metallic or polymer grommets or spacers 512. The grommets 512 hold the fins in place and a certain distance apart, while still permitting the fins to move along the length of mounting post 520.

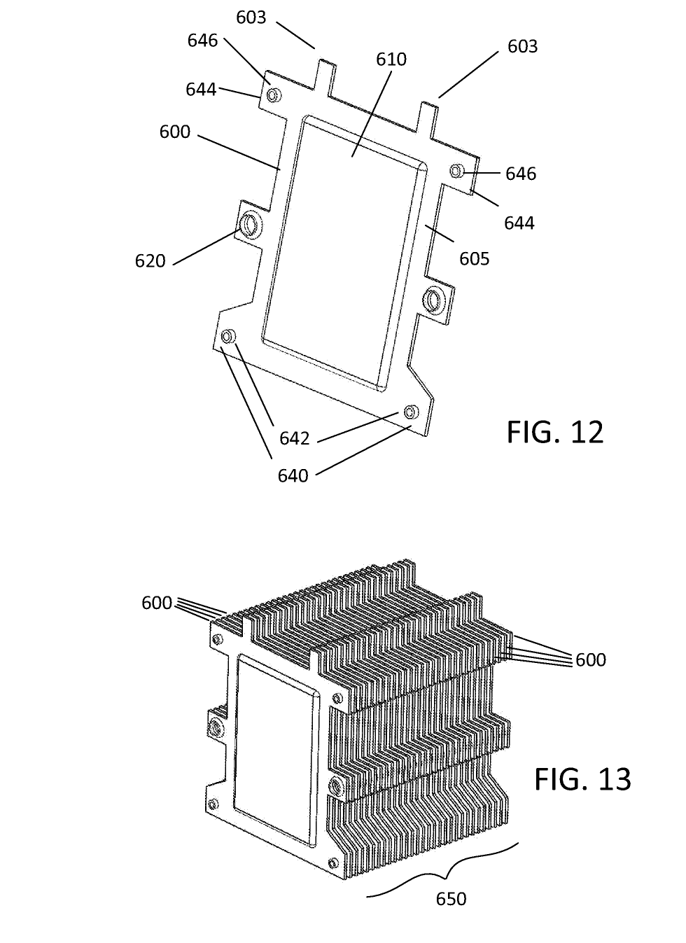

FIG. 12 illustrates an additional exemplary embodiment of a graphene enhanced cooling fin, including a battery cell containing depression and four structural mounting tabs. Cooling fin 600 is illustrated, including body portion 605, punched hole gripping features 620, battery cell holding depression 610, lower structural mounting tabs 640, and upper structural mounting tabs 644. Depression 610, the illustration showing a back side of the depression, creates an extended portion projecting from surface of body portion 605. Depression 610 adds to the structural rigidity of the cooling fin 600, such that a stack of cooling fins can be used to house a plurality of battery cells without other structural members. Tabs 603 are illustrated projecting from a top surface of fin 600. Such tabs can be used to locate other parts or components in a battery system to the stack of cooling fins.

Punched hole gripping features 620 include extended material that is bent outwardly away from the surface of the tabs by the punching process. This extended material increases surface area of contact between the tabs and a cooling tube inserted within gripping features 620.

Mounting tabs 640 and 644 include mounting holes 642 and 646, respectively, for insertion of a mounting post. By using holes 624 and 646 to mount the cooling fin and gripping features 620, wherein all of these features can be mounted to features that are longitudinally symmetrical normal to the face of body portion 605, the cooling fin 600 can slide along the attached features allowing the associated stack to be easily assembled, aligned, and constrained as a module, while allowing individual cell expansion and contraction as needed.

FIG. 13 illustrates a plurality of cooling fins of FIG. 12 assembled into a stack. A plurality of cooling fins 600 are assembled into cooling fin stack 650.

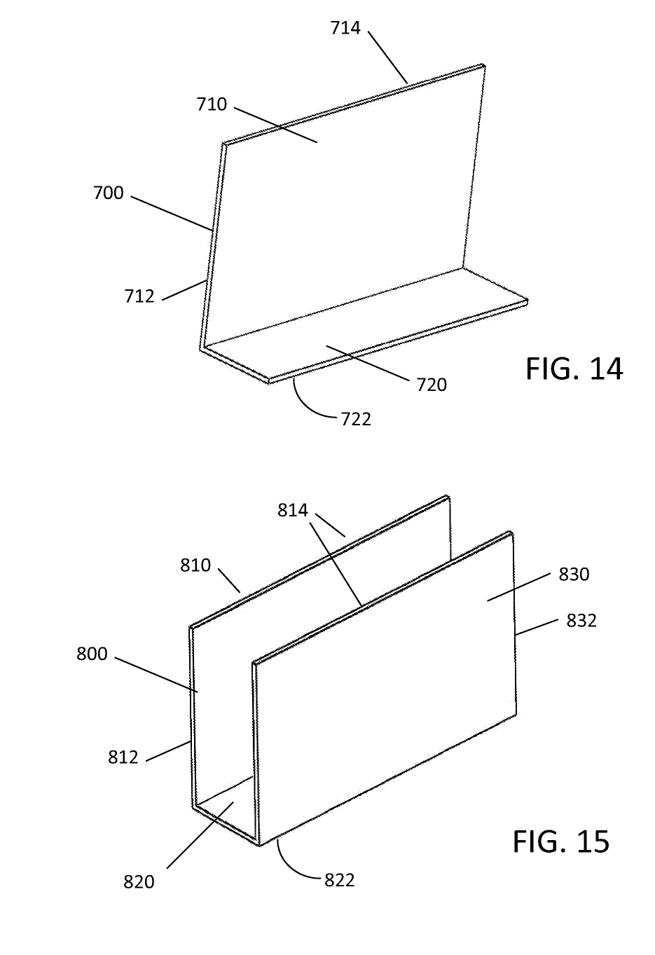

FIG. 14 illustrates an exemplary cooling fin with a bend configured to improve structural rigidity of the fin. Graphene enhanced cooling fin 700 is illustrated including a vertical body portion 710 and a horizontal body portion 720. Creating a bend in the fin increases rigidity of the fin, enhancing the structural properties of the fin when assembled as part of a battery pack. A battery cell can be situated resting upon horizontal portion 720 and extending up along and in contact with vertical portion 710. Cooling tabs or brackets including gripping features as disclosed herein can be attached to any of side edge 712, top edge 714, and bottom surface 722.

FIG. 15 illustrates an exemplary cooling fin with a plurality of bends configured to improve structural rigidity of the fin. Graphene enhanced cooling fin 800 is illustrated including a first vertical body portion 810, a horizontal body portion 820, and a second vertical body portion 830. Creating bends in the fin increases rigidity of the fin, enhancing the structural properties of the fin when assembled as part of a battery pack. A battery cell can be situated resting upon horizontal portion 820 and extending up along and in contact with both vertical portions 810 and 830. Cooling tabs or brackets including gripping features as disclosed herein can be attached to any of side edges 812 and 832, top edges 814, and bottom surface 822.

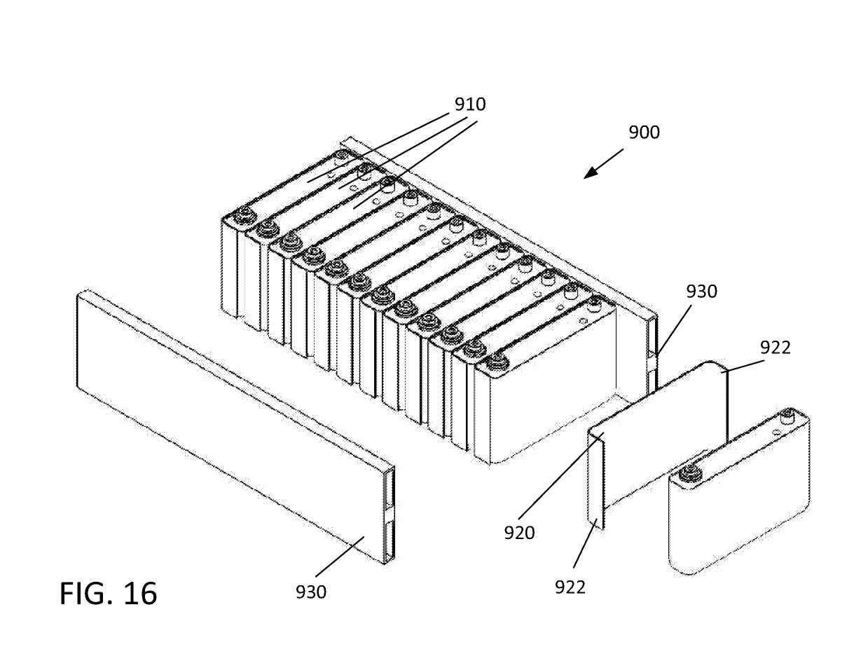

FIG. 16 illustrates an exemplary plurality of prismatic battery cells, each including a respective cooling fin wrapped thereabout. Configuration 900 is illustrated including a plurality of prismatic battery cells 910 and a plurality of corresponding cooling fins 920 configured to wrap around each battery cell 910. Cooling fins 920 each include two wrapping side sections 922 shaped to match the outer surface of a corresponding battery cell 910. Additionally, the outside surface of each side section 922 contacts and transfers heat to/from coolant tube assemblies 930 which are attached alongside the stacked battery cells and fins.

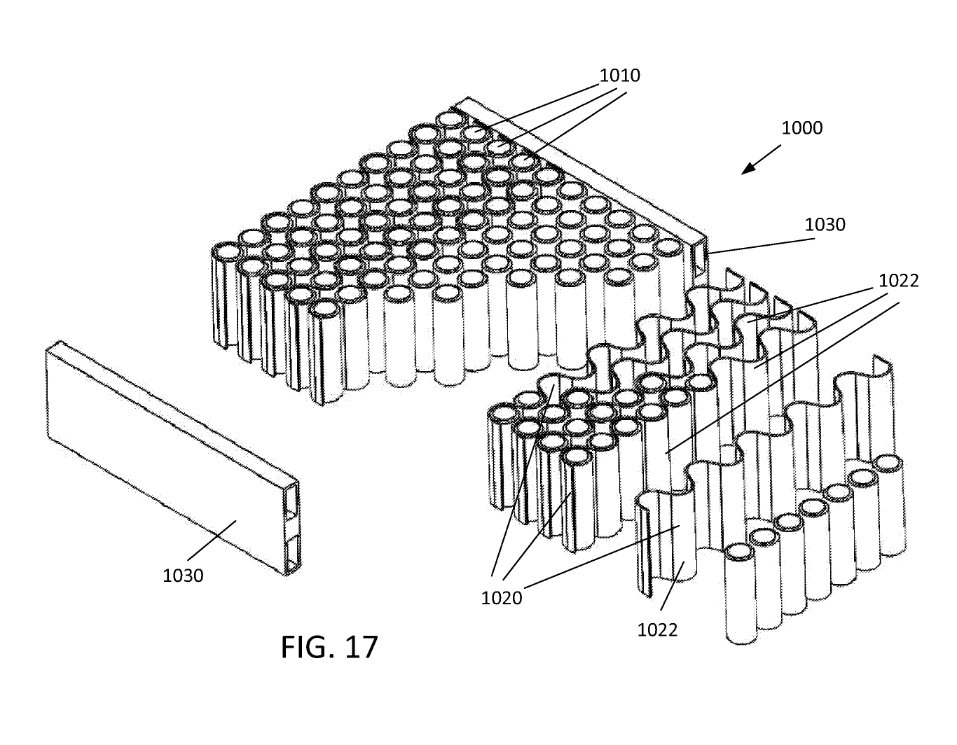

FIG. 17 illustrates an exemplary plurality of cylindrically-shaped energy storage devices and a plurality of cooling fins, each including arcuate sections configured to wrap around and contact the cylindrically-shaped energy storage devices. Configuration 1000 is illustrated including a plurality of cylindrically-shaped energy storage devices 1010 and a plurality of corresponding cooling fins 1020, each with arcuate sections 1022, configured to wrap around each energy storage device 1010. Cooling fins 1020 are configured to exchange heat with and structurally hold in place devices 1010. Additionally, the outside, side-most surfaces of each cooling fin 1020 contacts and transfers heat to/from coolant tube assemblies 1030 which are attached alongside the configuration.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An apparatus for cooling a multi-cell energy storage device, the apparatus comprising:
a plurality of cooling fins, each cooling fin comprising:
a metallic substrate; and
a cooling tube gripping feature; and
a cooling tube configured to transfer heat from the cooling fins to a flow of coolant within the cooling tube.

2. The apparatus of claim 1, wherein the metallic substrate comprises a graphene enhanced metallic substrate.

3. The apparatus of claim 2, wherein the graphene enhanced metallic substrate comprises a layer of graphene upon a single metal substrate.

4. The apparatus of claim 2, wherein the graphene enhanced metallic substrate comprises a plurality of graphene layers upon a single metal substrate.

5. The apparatus of claim 2, wherein the graphene enhanced metallic substrate comprises a layer of graphene upon a plurality of metal layers in the metallic substrate.

6. The apparatus of claim 2, wherein the graphene enhanced metallic substrate comprises a plurality of layers of graphene and a plurality of metal layers in the metallic substrate.

7. The apparatus of claim 2, wherein the graphene enhanced metallic substrate comprises graphene intermixed with metal in the metallic substrate.

8. The apparatus of claim 1, wherein the cooling fins are configured to move along the cooling tube.

9. The apparatus of claim 1, wherein each cooling fin further comprises a planar body portion.

10. The apparatus of claim 1, wherein each cooling fin further comprises a body portion with a rectangular depression configured to hold a battery cell within the depression.

11. The apparatus of claim 1, wherein each cooling fin further comprises a structural mounting tab extending outwardly from a body portion of the cooling fin.

12. The apparatus of claim 1, wherein the gripping feature comprises arcuate tabs configured to wrap around curved portions of the cooling tube.

13. The apparatus of claim 1, wherein the gripping feature comprises C-shaped tabs configured to wrap around curved portions of the cooling tube.

14. The apparatus of claim 1, wherein the gripping feature comprises a wrapping bracket configured to wrap around the cooling tube and be fastened to the cooling fin.

15. The apparatus of claim 1, wherein the gripping feature comprises a hole punched in a tab extending outwardly from a body portion of the cooling fin.

16. The apparatus of claim 15, wherein the hole comprises extended material bend upwardly away from a flat face of the tab.

17. The apparatus of claim 1, wherein the cooling fin further comprises a cooling fin spacing feature comprising bent material of the cooling fin.

18. The apparatus of claim 1, further comprising a grommet spacing feature configured to mount one of the cooling fins to a mounting post.

19. The apparatus of claim 1, wherein each of the cooling fins further comprises a mounting tab extending outwardly from a body portion of the cooling fin.

20. The apparatus of claim 19, wherein each of the mounting tabs for a respective cooling fin comprises a mounting hole configured to receive a mounting post oriented perpendicularly to a body portion of the respective cooling fin; and
wherein each of the gripping features for the respective cooling fin is configured to receive the cooling tube which is oriented perpendicularly to the body portion of the respective cooling fin.

21. The apparatus of claim 1, wherein each of the cooling fins further comprises a bend, the bend creating a horizontal portion of the cooling fin and a vertical portion of the cooling fin.

22. The apparatus of claim 1, each of the cooling fins further comprises a bend configured to wrap around a prismatic battery cell.

23. The apparatus of claim 1, wherein each of the gripping features for a respective cooling fin is configured to receive the cooling tube which is oriented perpendicularly to the body portion of the respective cooling fin.

24. The apparatus of claim 1, wherein each of the cooling fins comprises a plurality of arcuate sections configured to wrap around a plurality of cylindrically-shaped energy storage cells.
